(19) United States
(12) Patent Application Publication
(10) Pub. No.: US 2025/0351233 A1
(43) Pub. Date: Nov. 13, 2025

(54) Heated Ceiling Fan Device

(71) Applicant: Jeff Cecil, Tampa, FL (US)

(72) Inventor: Jeff Cecil, Tampa, FL (US)

(21) Appl. No.: 19/017,935

(22) Filed: Jan. 13, 2025

Related U.S. Application Data
(60) Provisional application No. 63/646,085, filed on May 13, 2024.

(51) Int. Cl. H05B 3/00; F24H 3/06

(52) U.S. Cl. CPC H05B 3/008; F24H 3/062

(57) ABSTRACT

A heated ceiling fan device is disclosed that enables users to enjoy the outdoor environment in cool temperatures. The heated ceiling fan device comprises a ceiling fan with at least one heating element positioned on the bottom surface of each fan blade. The heating element output can be controlled by a remote control to achieve a desired temperature while the fan rotates. In one embodiment, the heating element is comprised of an infrared bulb. The fan can also be comprised of a speaker that can wirelessly connect with a sound device. Additionally, the fan can comprise a camera for additional security. Finally, the fan can also include a plurality of mist nozzles for additional protection from outdoor insects while providing a pleasant aroma.

### CROSS-REFERENCE TO RELATED APPLICATION

The present application claims priority to, and the benefit of, U.S. Provisional Application No. 63/646,085, which was filed on May 13, 2024, and is incorporated herein by reference in its entirety.

### FIELD OF THE INVENTION

The present invention relates generally to the field of ceiling fan devices. More specifically, the present invention relates to an improved ceiling fan with multiple heating components attached to the fan blades enabling users to enjoy an outdoor fan in cooler temperatures. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in ceiling fan devices. Generally, many individuals enjoy sitting under outdoor fans to provide a method of cooling during warm temperatures. However, sitting under an outdoor fan is not practical when it is cold outside. Further, this leads users to becoming too cold by the surrounding cold air while under the fan. This limits ceiling fan devices to be only used in warm climates or warm seasons/temperatures.

Additionally, there are times when users would like to enjoy an outdoor ceiling fan without it creating a cooler temperature. At such times if a ceiling fan is available that prevents users from becoming cold, they can enjoy a ceiling fan in various temperatures. Further, if users have access to a ceiling fan that can heat users while in use, they can experience an outdoor ceiling fan in cooler temperatures. However, most ceiling fans tend to only provide a method for creating a cooler space and become difficult to use during all seasons of the year.

Accordingly, there is a demand for an improved ceiling fan device that prevents users from becoming too cold by the surrounding cold air while under the fan. More particularly, there is a demand for a heated ceiling fan device that enables users to be heated while positioned underneath the fan ensuring user comfort in a plurality of climates.

Therefore, there exists a long felt need in the art for a heated ceiling fan device that provides users with an improved ceiling fan with multiple heating components that provide comfort in all outdoor temperatures. There is also a long felt need in the art for a heated ceiling fan device that enables users to enjoy the outdoors during all seasons of the year. Further, there is a long felt need in the art for a heated ceiling fan device that provides a cost-effective way to heat an outdoor space. Finally, there is a long felt need in the art for a heated ceiling fan device that enables users to achieve a desired temperature while the fan rotates using a remote for added convenience.

The subject matter disclosed and claimed herein, in one embodiment thereof, comprises a heated celling fan device. The device is a remote-controlled ceiling fan capable of heating an outdoor space for enjoyment through all seasons of the year. The heated ceiling fan device comprises a base component comprising a standard electrical plug along with mist nozzle components secured to the base component. Further, a neck component is used to secure the motor component to the device. The neck component length can be adjusted to meet the user's desired space. Further, the motor component is the main power source used to control the fan blade components comprising the heating element components. Additionally, the motor component powers the camera component and speaker components. The device also includes a wireless remote-control component to control the device. Accordingly, the device makes enjoying outdoor living spaces during cooler temperatures easier for users. The device also accounts for comfortability of the user during use.

In this manner, the heated ceiling fan device of the present invention accomplishes all of the forgoing objectives and provides users with a device that helps users enjoy outdoor environments during all seasons of the year. The device can provide a plurality of fan blades and heating components with a remote control.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a heated celling fan device. The device is a remote-controlled ceiling fan capable of heating an outdoor space for enjoyment through all seasons of the year. The heated ceiling fan device comprises a base component comprising a standard electrical plug component along with mist nozzle components secured to the base component. Further, a neck component is used to secure the motor component to the base component. The neck component length can be adjusted to meet the user's desired space. Further, the motor component is the main power source used to control the fan blade components comprising the heating element components. The device also includes a wireless remote-control component to control the device. Accordingly, the device makes enjoying outdoor living spaces during cooler temperatures more comfortable for the users. The device also accounts for comfortability of the user during use.

In one embodiment, the heated ceiling fan device is made up, at a minimum, of the following components: a base component comprising an electric plug component, a neck component which connects to a motor component, a fan blade component comprising a heating element, and a handheld remote control to operate the device. Optional items may be added to create additional functionality or increase safety, as needed.

In one embodiment, the base component is most often formed from round aluminum to contain and secure the power source to the desired ceiling placement. In some instances, the base component can be made of different materials such as carbon fiber or steel, or any combination thereof. The shape of the base component is formed to create a flush seal to the desired ceiling. The base component has dimensions such that it will act as a guard to the electrical power source cords when mounted onto the ceiling.

In one embodiment, the base component comprises a neck component which connects to the motor component of the heated ceiling fan device. Further, size of the neck component can be adjusted in length to enable the device to be installed on a plurality of ceilings. The motor component provides power to the heating element embedded onto each fan blade component. Additionally, the motor component enables the fan blade components to be rotated either clockwise or counterclockwise. The heat mechanisms can also provide warmth while the fan blade components are in a stationary position and/or in a rotating position.

In one embodiment, each fan blade component comprises a heating element providing warmth when the device is in use. The heating elements can be powered off while the fan blade components are in use. The fan blades can provide a cooling breeze when rotated counterclockwise while they can also circulate warm air around the room when rotated clockwise. Further, the fan blade components are formed using a heat resistant metal material, such as stainless steel, to prevent damage when the heating elements are in use.

In one embodiment, the device is operated using a wireless or detached remote control. The remote control is preferably powered using disposable batteries, such as AA or AAA. The remote control enables the user to specify the speed of the fan blade components and the direction of the fan blade components. It also has functions for the user to specify when to start or stop the movement of the fan blade components. Finally, it also has functions to enable the temperature of the heating elements to be set to a specific temperature.

In yet another embodiment, a method of heating an outdoor environment is disclosed. The method includes the steps of providing a heated ceiling fan device comprising a base component, motor component, and fan blade components comprising heating elements. The method also comprises powering the device using the standard electrical plug wires. Further, the method comprises securing the device to the desired ceiling space until the base component is flush to the ceiling. The method also comprises powering “ON” the device using the wireless remote control. Finally, the method comprises easily adjusting the desired temperature of the heating elements using the wireless remote.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the heated ceiling fan device of the present invention in accordance with the disclosed architecture;

FIG. 2 illustrates a perspective view of one embodiment of the base component of the heated ceiling fan device of the present invention comprising mist nozzle components in accordance with the disclosed architecture;

FIG. 3 illustrates a perspective view of one embodiment of the heated ceiling fan device of the present invention from underneath the device in accordance with the disclosed architecture;

FIG. 4 illustrates a perspective view of one potential embodiment of the motor component of the heated ceiling fan device of the present invention showing a camera and speaker component of the present invention in accordance with the disclosed architecture;

FIG. 5 illustrates a perspective view of one potential embodiment of the motor component of the heated ceiling fan device of the present invention showing a light component in accordance with the disclosed architecture;

FIG. 6 illustrates a perspective view of one embodiment of the heated ceiling fan device of the present invention showing the device in accordance with the disclosed architecture;

FIG. 7 illustrates a side view of one potential embodiment of the heated ceiling fan device of the present invention without the camera component in accordance with the disclosed architecture;

FIG. 8 illustrates a side view of one embodiment of the heated ceiling fan device of the present invention showing the camera component in accordance with the disclosed architecture;

FIG. 9 illustrates multiple perspective views of one embodiment of the heated ceiling fan device of the present invention in accordance with the disclosed architecture; and

FIG. 10 illustrates a flowchart showing the method of operating and heating an environment in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a heated ceiling fan device that provides users with an improved ceiling fan with multiple heating components that provide comfort in a plurality of outdoor temperatures. There is also a long felt need in the art for a heated ceiling fan device that enables users to enjoy the outdoors during all seasons of the year. Further, there is a long felt need in the art for a heated ceiling fan device provides a cost-effective way to heat an outdoor space. Finally, there is a long felt need in the art for a heated ceiling fan device that enables users to achieve a desired temperature while the fan rotates using a remote for added convenience.

The present invention, in one exemplary embodiment, is a novel ceiling fan device. The device is a remote-controlled ceiling fan capable of heating an outdoor space for enjoyment through all seasons of the year. The heated ceiling fan device comprises a base component comprising a standard electrical plug along with mist nozzle components secured to the base component. Further, a neck component is used to secure the motor component to the base component. The motor component is the main power source used to control the fan blade components comprising the heating elements. The device also includes a wireless remote-control component to control the device. The present invention also includes a novel method of warming an outdoor environment. The method includes the steps of providing a heated ceiling fan device comprising a base component, motor component, and fan blade components comprising heating elements. The method also comprises powering the device using the electrical plug components. Further, the method comprises securing the device to the desired ceiling space until the base component is flush to the ceiling. The method also comprises powering “ON” the device using the wireless remote control. Finally, the method comprises easily adjusting the desired temperature of the heating elements using the wireless remote.

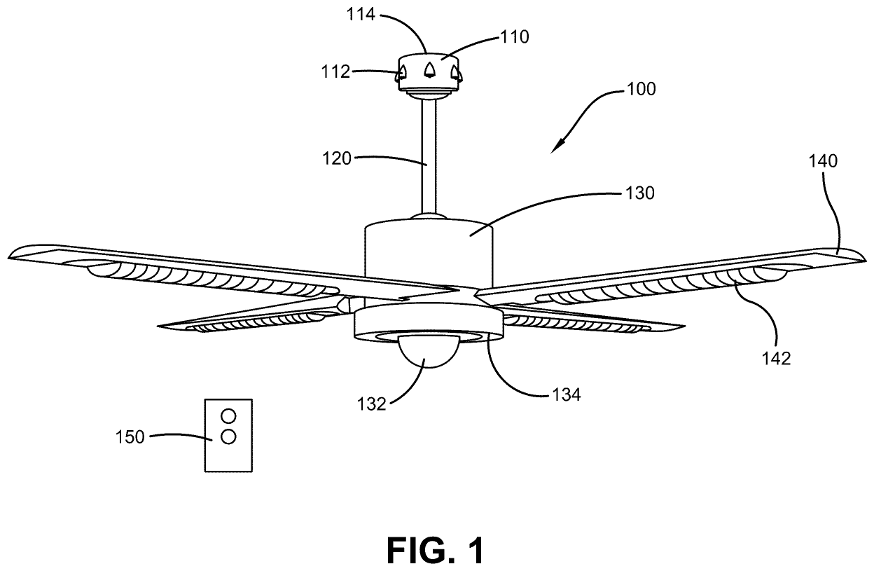

Referring initially to the drawings, FIG. 1 illustrates a perspective view of one embodiment of the heated ceiling fan device 100 of the present invention. In the present embodiment, the heated ceiling fan device 100 provides users with a means for increasing the temperature of a specific environment. Specifically, the heated ceiling fan device 100 comprises a base component 110 comprising at least one standard electrical plug component 114 along with at least one mist nozzle component 112 secured to the base component 110. Further, a neck component 120 is used to secure the motor component 130 to the base component 110. The neck component 120 length can be adjusted in length to enable the device to be installed on a plurality of ceilings. Further, the motor component 130 is the main power source used to control at least one fan blade component 140 comprising at least one heating element component 142. Accordingly, the device 100 makes enjoying outdoor living spaces during cooler temperatures easier for users. The device 100 also accounts for comfortability of the user during use.

Generally, the heated ceiling fan device 100 is made up, at a minimum, of the following components: a base component 110 comprising an electric plug component 114, a neck component 120 which connects to a motor component 130, a fan blade component 140 comprising a heating element 142, and a handheld remote control 150 to operate the device 100. Optional items such as but not limited to at least one mist nozzle component 112, at least one camera component 132, and at least one speaker component 134, may be added to create additional functionality or increase safety, as needed.

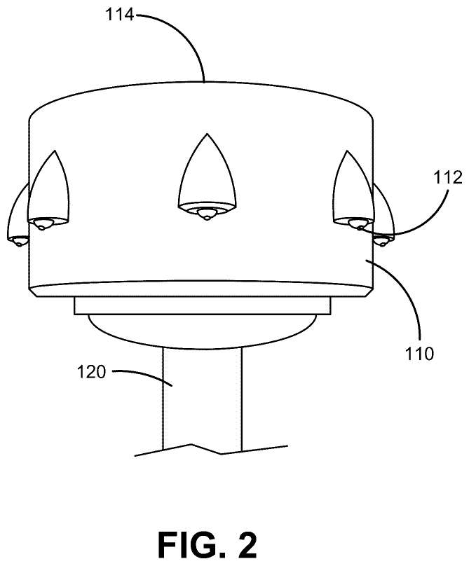

As shown in FIG. 2, the base component 110 is most often formed of from round aluminum to contain and secure the electric plug component 114 to the desired ceiling placement. In some instances, the base component 110 can be made of different materials such as carbon fiber or steel, or any combination thereof. The shape of the base component is formed to create a flush seal to the desired ceiling. The base component has dimensions such that it will act as a guard to the electric plug component 114 when mounted onto the ceiling.

In some instances, the base component 110 can comprise a plurality of mist nozzle components 112. Further, the mist nozzle components 112 can provide moisture to the environment to cool the user. Additionally, the mist nozzle components 112 can provide scents through the use of essential oils or other specially designed scented liquids for the device 100. Finally, the mist nozzle components 112 can provide protection to the user from outdoor insects through the oils, scents, repellants, and sprays used in the device 100, leading to a more enjoyable experience in the environment.

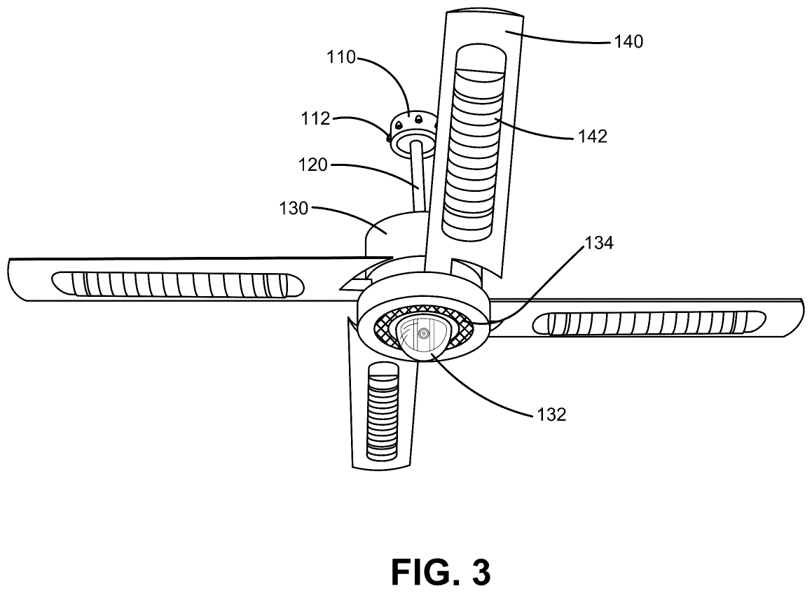

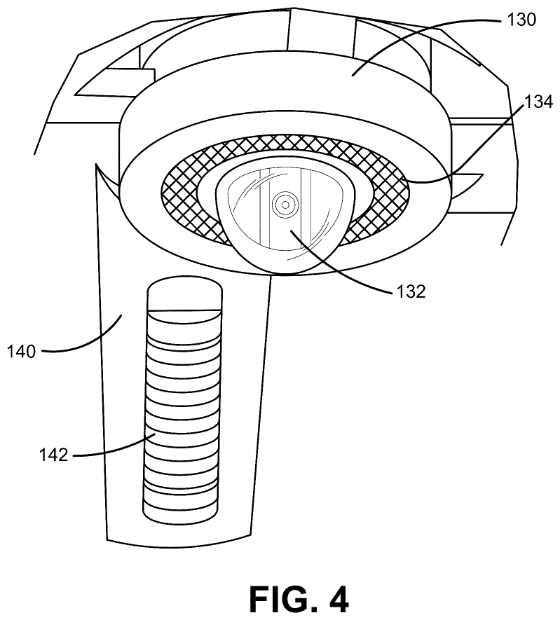

As shown in FIGS. 3-4, the device 100 is preferably made with at least one camera component 132 and at least one speaker component 134. Further, the camera component 132 provides additional security to the user. The camera component 132 is utilized through wireless internet to provide monitoring on the user's computer, cellular phone, or other compatible device. Additionally, the speaker component 134 is utilized through wireless internet to provide additional entertainment for the user. The speaker component 134 projects sound from a linked television, a linked music source (i.e., cellphone), and/or other linked compatible devices. Finally, both the camera component 132 and the speaker component 134 can be controlled using a wireless remote component 150.

Further, the wireless remote-control component 150 enables the user to adjust the level of sound, pairing of compatible (i.e., linked) devices, set a timer, and other necessary tasks. The remote-control component 150 is preferably powered using disposable batteries, such as, but not limited to, AA or AAA. The remote-control component 150 enables the user to specify the speed of the fan blade components 140 and the direction of the fan blade components 140. It also has functions for the user to specify when the start or stop the movement of the fan blade components 140. Finally, it also has functions to enable the temperature of the heating elements 142 to be set to a specific temperature.

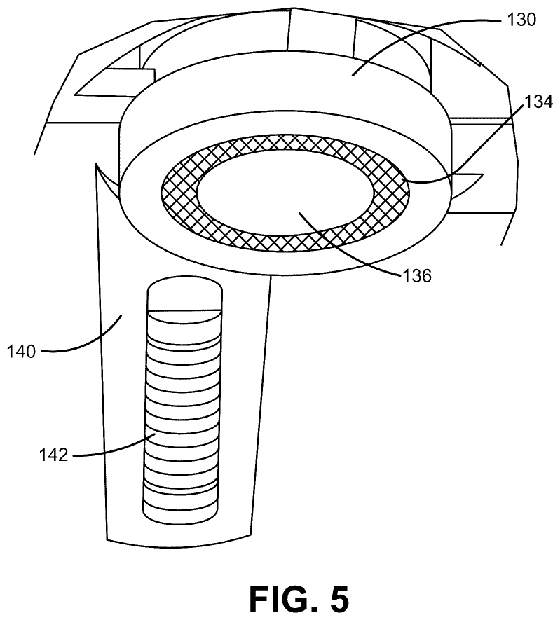

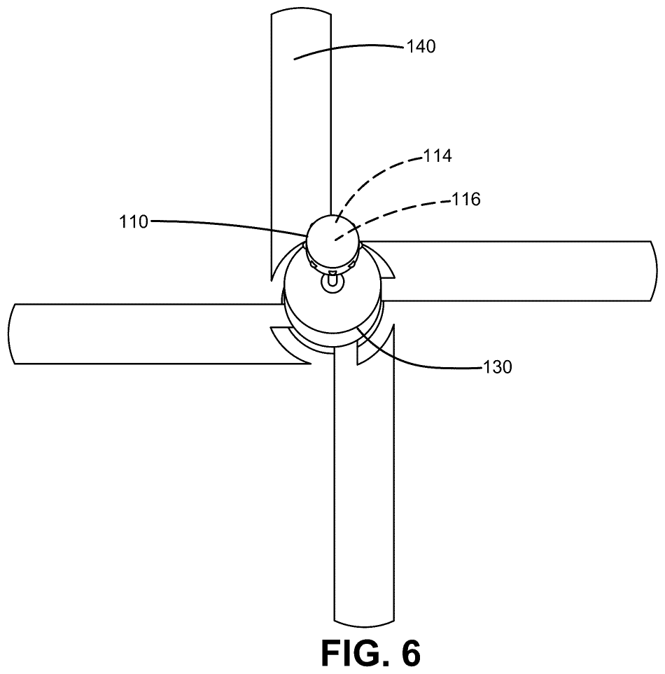

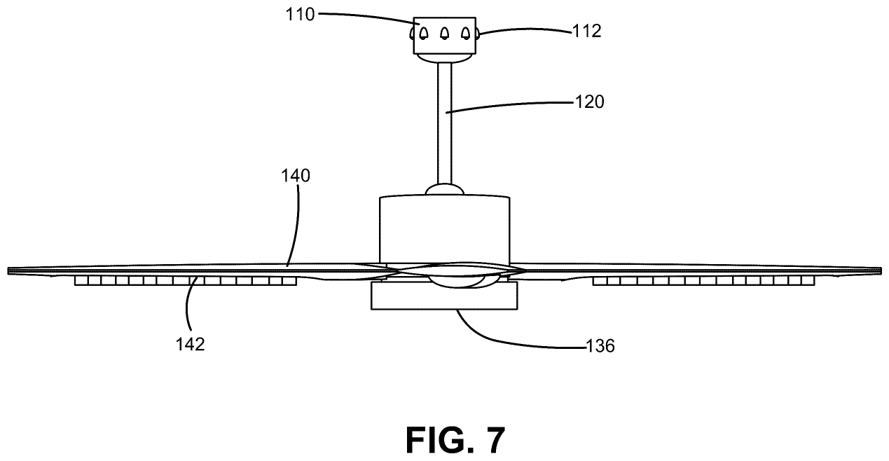

Referring to FIGS. 5-7, in one embodiment, the device 100 is designed comprising at least one light component 136. Further, the light component 136 replaces the camera component 132. The light component 136 enables users to utilize the device 100 in dimly lit conditions providing additional illumination and duration for entertainment purposes. Additionally, the light component 136 is controlled through the wireless remote control 150. In another embodiment, all functions of the wireless remote control 150 are utilized using a wireless compatible device through wireless internet.

Additionally, the motor component 130, such as an electric motor, provides power to all accessories and functions of the device 100. The motor component 140 is powered through the electric plug component 114 that can be wired into standard electrical wiring in the ceiling. In another embodiment, the motor component 130 can be powered by a solar panel component 116 through sun exposure. Moreover, the motor component 130 enables the device 100 to rotate in either clockwise or counterclockwise motions.

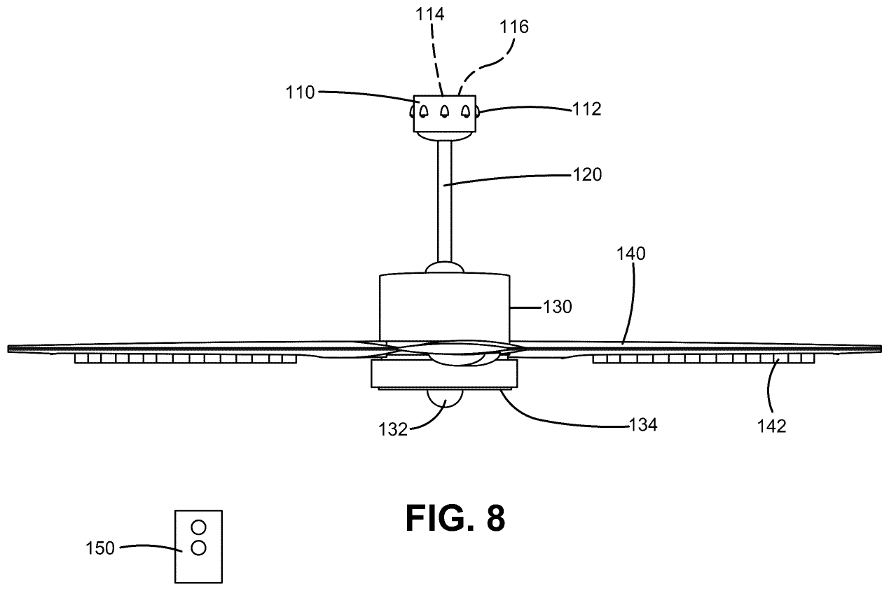

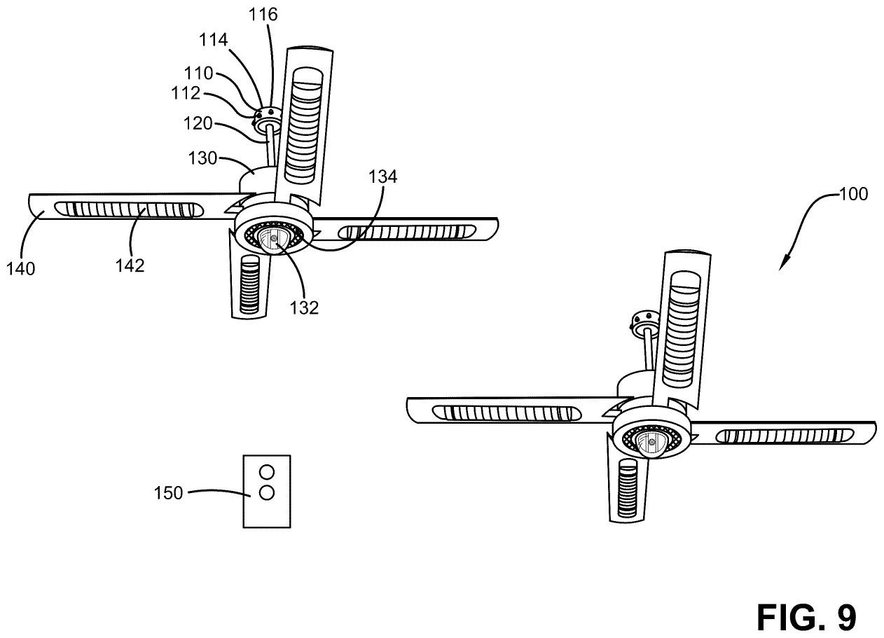

Referring to FIGS. 8-9, one embodiment of the heated ceiling fan device 100 of the present invention is shown in accordance with the disclosed architecture. Further, at least one fan blade component 140 is present on the device 100. Moreover, the fan blade component 140 is preferably made from a durable, heat resistant metal material such as aluminum, to prevent damage to the device while the heating element 142 is in use. However, the fan blade component 140 may be made from any material known in the art.

Additionally, each fan blade component 140 provided comprises at least one heating element 142 that provides air flow to the user. The fan blade components 140 can provide a cooling breeze when rotated counterclockwise while they can also circulate warm air around the room when rotated clockwise. Further, the heating element 142 is preferably an infrared heater. However, the heating element 142 may be made from any material known in the art. The heating elements 142 can be powered off while the fan blade components 140 are in use to eliminate additional air flow. The heating elements 142 can provide warmth while the fan blade components 140 are in a stationary position.

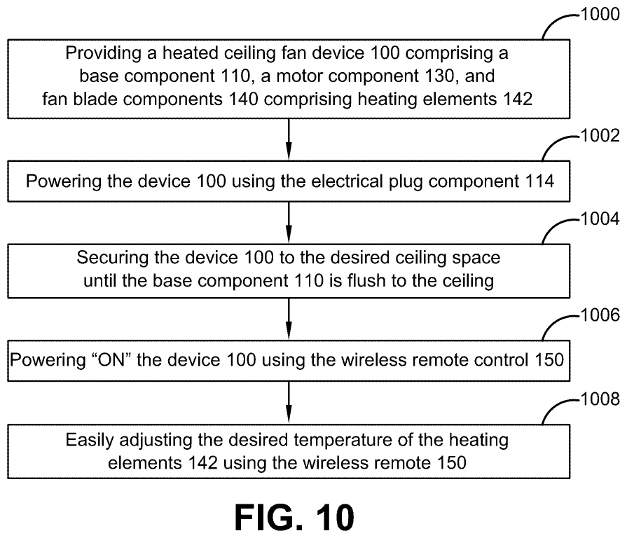

FIG. 10 illustrates a flowchart of the method of operating and heating an environment. The method includes the steps of 1000, providing a heated ceiling fan device 100 comprising a base component 110, a motor component 130, and fan blade components 140 comprising heating elements 142. The method also comprises at 1002 powering the device 100 using the electrical plug component 114. Further, the method comprises at 1004 securing the device 100 to the desired ceiling space until the base component 110 is flush to the ceiling. The method also comprises at 1006 powering “ON” the device 100 using the wireless remote control 150. Finally, the method comprises at 1008 easily adjusting the desired temperature of the heating elements 142 using the wireless remote 150.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “heated ceiling fan device”, “fan device”, “heated outdoor ceiling fan”, and “device” are interchangeable and refer to the heated ceiling fan device 100 of the present invention.

Notwithstanding the forgoing, the heated ceiling fan device 100 of the present invention can be of any suitable size and configuration as is known in the art without affecting the overall concept of the invention, provided that it accomplishes the above stated objectives. One of ordinary skill in the art will appreciate that the heated ceiling fan device 100 as shown in FIGS. 1-10 is for illustrative purposes only, and that many other sizes and shapes of the heated ceiling fan device 100 are well within the scope of the present disclosure. Although the dimensions of the heated ceiling fan device 100 are important design parameters for user convenience, the heated ceiling fan device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A heated ceiling fan device comprising:
a base;
an electrical plug;
a neck;
a motor;
a plurality of fan blades; and
at least one heating element;
wherein said neck having an adjustable length for connecting said base to said motor; and
further wherein said at least one heating element attached to at least one of said plurality of fan blades.

2. The heated ceiling fan device of claim 1 further comprising a handheld remote control to operate said heated ceiling fan device.

3. The heated ceiling fan device of claim 1 further comprising at least one mist nozzle, wherein said at least one mist nozzle secured to said base component for providing moisture to an area surrounding said heated ceiling fan device.

4. The heated ceiling fan device of claim 1 further comprising at least one camera, wherein said at least one camera for monitoring an area surrounding said heated ceiling fan device.

5. The heated ceiling fan device of claim 1 further comprising at least one speaker, wherein said at least one speaker having a wireless connection to a device selected from the group consisting of a television and a cell phone.

6. The heated ceiling fan device of claim 1 further comprising a plurality of mist nozzle components, wherein said plurality of mist nozzles secured to said base component for providing moisture to an area surrounding said heated ceiling fan device.

7. The heated ceiling fan device of claim 6, wherein said moisture having essential oils for scenting the area surrounding said heated ceiling fan device.

8. The heated ceiling fan device of claim 7, wherein said moisture having repellants for repelling insects from the area surrounding said heated ceiling fan device.

9. The heated ceiling fan device of claim 5 further comprising a wireless remote control, wherein said wireless remote control adjusting a level of sound of said at least one speaker and adjusting a timer of said heated fan device.

10. The heated ceiling fan device of claim 9, wherein said wireless remote control adjusting a timer of said plurality of fan blades for starting and stopping said heated fan device.

11. The heated ceiling fan device of claim 10, wherein said wireless remote control adjusting a speed of said plurality of fan blades.

12. The heated ceiling fan device of claim 11, wherein said wireless remote control adjusting a direction of said plurality of fan blades.

13. The heated ceiling fan device of claim 12, wherein said wireless remote control adjusting a temperature of said plurality of heating elements.

14. The heated ceiling fan device of claim 12, wherein said plurality of blades having heat resistant metal material.

15. A heated ceiling fan device comprising:
a base;
a neck;
a motor;
a plurality of fan blades; and
a plurality of heating elements;
wherein said neck for connecting said base to said motor;
wherein at least one of said plurality of heating elements attached to each of said plurality of fan blades; and
further wherein said plurality of heating elements are infrared heaters.

16. The heated ceiling fan device of claim 15 further comprising at least one mist nozzle, wherein said at least one mist nozzle secured to said base component for providing moisture to an area surrounding said heated ceiling fan device.

17. The heated ceiling fan device of claim 16 further comprising at least one camera, wherein said at least one camera for monitoring an area surrounding said heated ceiling fan device.

18. The heated ceiling fan device of claim 17 further comprising at least one speaker, wherein said at least one speaker having a wireless connection to a device selected from the group consisting of a television and a cell phone.

19. The heated ceiling fan device of claim 16, wherein said moisture having essential oils for scenting the area surrounding said heated ceiling fan device.

20. A heated ceiling fan device comprising:
a base;
a neck;
a motor;
a plurality of fan blades;
a wireless remote control; and
a plurality of heating elements;
wherein said neck for connecting said base to said motor;
wherein at least one of said plurality of heating elements attached to each of said plurality of fan blades;
wherein said plurality of heating elements are infrared heaters;
wherein said wireless remote control adjusting a temperature of said plurality of heating elements; and
further wherein said plurality of blades having heat resistant metal material.
